(19) United States
(12) Patent Application Publication
(10) Pub. No.: US 2024/0282510 A1
(43) Pub. Date: Aug. 22, 2024

(54) COIL DEVICE

(71) Applicant: TDK CORPORATION, Tokyo (JP)

(72) Inventors: Kazunori ARIMITSU, Tokyo (JP); Kiichi FUJISAWA, Tokyo (JP); Masashi HAMA, Tokyo (JP); Nobuo KITAJIMA, Tokyo (JP); Fuyuki MIURA, Tokyo (JP); Takehiko NARISAWA, Tokyo (JP); Masanori SATO, Tokyo (JP)

(73) Assignee: TDK CORPORATION, Tokyo (JP)

(21) Appl. No.: 18/583,170

(22) Filed: Feb. 21, 2024

(30) Foreign Application Priority Data
Feb. 22, 2023 (JP) 2023-026404

(51) Int. Cl. H01F 27/29; H01F 27/28

(52) U.S. Cl. CPC H01F 27/292; H01F 27/2828

(57) ABSTRACT

A coil device has a wound portion, a leadout portion led out from the wound portion, a terminal including a wire connecting portion connected to the leadout portion, and an element body covering the wound portion, the leadout portion and the wire connecting portion. A winding axis of the wound portion is perpendicular to a mounting facing surface of the element body. The leadout portion has a bent portion bent so as to protrude inward when viewed along the winding axis, and an inner angle of the bent portion is an obtuse angle.

### BACKGROUND OF THE INVENTION

### 1. Technical Field

The present disclosure relates to a coil device.

### 2. Description of the Related Art

WO 2017/115604 A discloses, as a coil device used as, for example, an inductor, a coil device having a wound portion, a leadout portion led out from the wound portion, and an element body in which the wound portion and the leadout portion are embedded. A space is formed between the leadout portion and an outer circumferential surface of the wound portion, and a part of the element body is filled in the space.

In this type of coil device, compression molding may be performed in a state where the wound portion and the leadout portion are embedded in a magnetic material constituting the element body. In this case, the leadout portion is pressed toward the outer circumferential surface of the wound portion by a molding pressure during the compression molding. As a result, when the leadout portion is displaced toward the outer circumferential surface of the wound portion, a density of the magnetic material entering the space between the leadout portion and the outer circumferential surface of the wound portion increases, and a short circuit failure may occur between the leadout portion and the outer circumferential surface of the wound portion via the magnetic material.

### CITATION LIST

### Patent Literature

Patent Literature 1: WO 2017/115604 A

### SUMMARY OF THE INVENTION

The present disclosure has been made in view of such circumstances, and an object of the present disclosure is to provide a coil device capable of preventing occurrence of a short circuit failure between a leadout portion and an outer circumferential surface of a wound portion.

In order to achieve the above object, a coil device of the present disclosure includes:
a wound portion;
a leadout portion led out from the wound portion;
a terminal including a wire connecting portion connected to the leadout portion; and
an element body covering the wound portion, the leadout portion and the wire connecting portion, in which
a winding axis of the wound portion is perpendicular to a mounting facing surface of the element body,
the leadout portion has a bent portion bent so as to protrude inward when viewed along the winding axis, and
an inner angle of the bent portion is an obtuse angle.

In the coil device of the present disclosure, the leadout portion has a bent portion bent so as to protrude inward when viewed along the winding axis. Therefore, depending on a bending degree of the bent portion, a part of the leadout portion is disposed in the vicinity of the outer circumferential surface of the wound portion, and a space is hardly formed between the leadout portion and the outer circumferential surface of the wound portion. Therefore, at the time of manufacturing the coil device, the magnetic material constituting the element body is less likely to enter between the leadout portion and the outer circumferential surface of the wound portion. This makes it possible to prevent a short circuit failure between the leadout portion and the outer circumferential surface of the wound portion via the magnetic material. In addition, since a part of the leadout portion is disposed in the vicinity of the outer circumferential surface of the wound portion, a number of turns of the wound portion can be increased, and magnetic properties of the coil device can be improved. In addition, since an inner angle of the bent portion is an obtuse angle, the leadout portion is not excessively bent at the bent portion, and it is possible to prevent a variation in electrical properties of the coil device due to the bending of the leadout portion.

The bent portion may be adjacent to the outer circumferential surface of the wound portion.

The leadout portion may have a proximal end portion located on one side of the bent portion and a distal end portion located on another side of the bent portion, and the proximal end portion may be closer to the outer circumferential surface of the wound portion than the distal end portion.

The winding axis of the wound portion may be offset to a one side with respect to a center of the element body, and the one side is a side where the leadout portion is disposed.

The leadout portion may have a first leadout portion and a second leadout portion displaced from the first leadout portion along the winding axis of the wound portion, and the bent portion may have a first bent portion provided in the first leadout portion and a second bent portion provided in the second leadout portion.

The distal end portion may have a first distal end portion provided in the first leadout portion and a second distal end portion provided in the second leadout portion, and an interval between the first distal end portion and the second distal end portion may be smaller than a maximum diameter of the wound portion.

The leadout portion may be provided with the bent portions.

The wound portion may be a flat wire wound in a spiral shape.

### BRIEF DESCRIPTION OF THE DRAWINGS

FIG. 1 is a perspective view of a coil device according to a first embodiment;

FIG. 2 is a perspective view illustrating an internal configuration of the coil device illustrated in FIG. 1;

FIG. 3 is a perspective view of a first core constituting a core illustrated in FIG. 1;

FIG. 4 is a perspective view of a second core constituting the core illustrated in FIG. 1;

FIG. 5A is a perspective view of a wound portion illustrated in FIG. 2;

FIG. 5B is a plan view of the wound portion illustrated in FIG. 5A;

FIG. 5C is a plan view of the wound portion illustrated in FIG. 5A;

FIG. 6 is a perspective view of terminals illustrated in FIG. 2;

FIG. 7A is a perspective view when leadout portions are connected to the terminals illustrated in FIG. 6;

FIG. 7B is a side view of the terminals and the wound portion illustrated in FIG. 7A as viewed in a Y-axis direction;

FIG. 8A is a view illustrating a method of manufacturing the coil device illustrated in FIG. 1;

FIG. 8B is a view illustrating a step subsequent to FIG. 8A;

FIG. 8C is a view illustrating a step subsequent to FIG. 8B;

FIG. 8D is a view illustrating a step subsequent to FIG. 8C;

FIG. 8E is a view illustrating a step subsequent to FIG. 8D;

FIG. 8F is a view illustrating a step subsequent to FIG. 8E;

FIG. 9 is a plan view of a wound portion of a coil device according to a second embodiment;

FIG. 10 is a plan view of a wound portion of a coil device according to a third embodiment;

FIG. 11 is a plan view of a modification of the leadout portion illustrated in FIG. 10;

FIG. 12A is a perspective view of a modification of the wound portion illustrated in FIG. 5A; and

FIG. 12B is a plan view of the wound portion illustrated in FIG. 12A.

### DETAILED DESCRIPTION

Hereinafter, embodiments of the present disclosure will be described with reference to the drawings. Note that the illustrated contents are merely schematic and exemplary for understanding the present disclosure, and the appearance, the dimensional ratio, and the like may be different from the actual ones. Further, the present disclosure is not limited to the following embodiments.

### First Embodiment

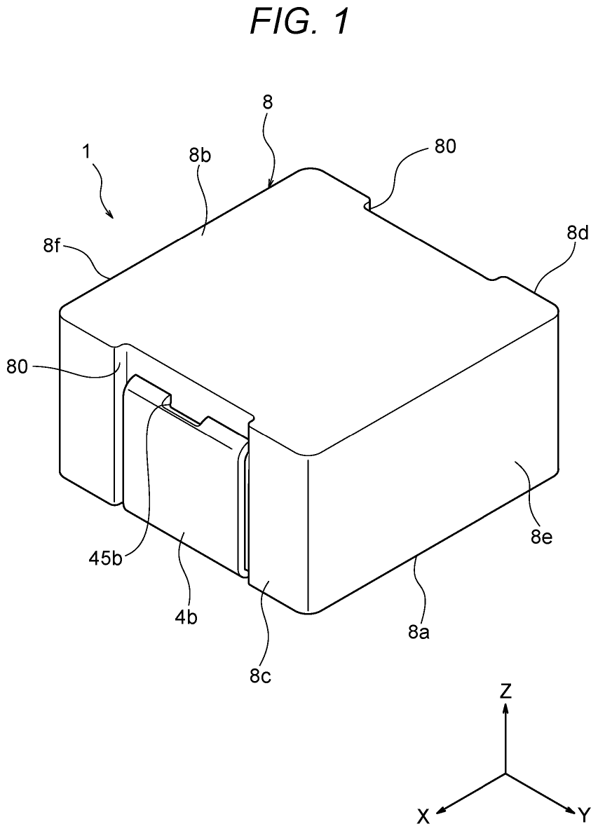

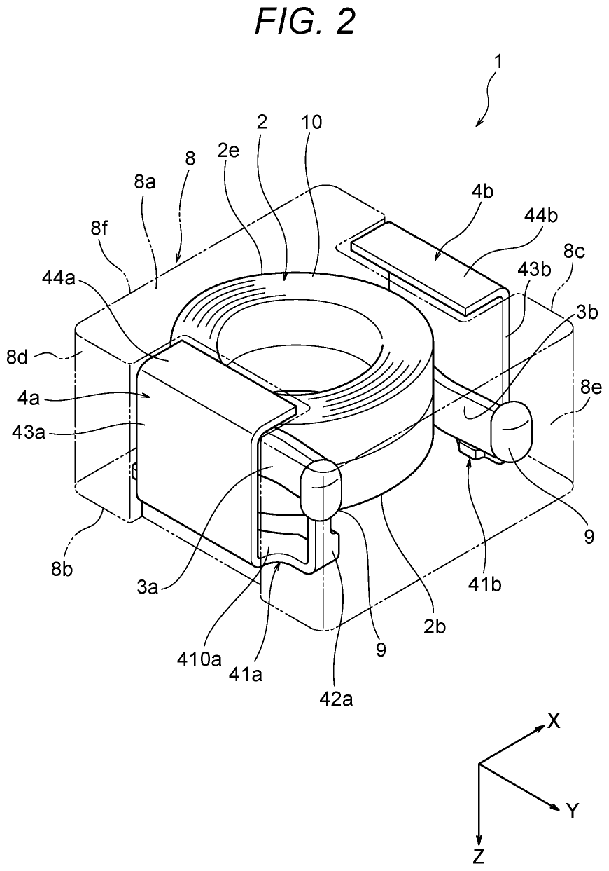

A coil device 1 of the first embodiment illustrated in FIG. 1 is, for example, a surface mount inductor, and is mounted on a mounting substrate of various electronic devices. As illustrated in FIG. 2, the coil device 1 has a wound portion (coil) 2, leadout portions 3a and 3b, terminals 4a and 4b, and a core (element body) 8.

The wound portion 2, the leadout portions 3a and 3b, and a part of each of the terminals 4a and 4b (wire connecting portions 42a and 42b to be described later) are embedded inside the core 8. The core 8 has a first surface 8a, a second surface 8b facing the first surface 8a, a third surface 8c, a fourth surface 8d facing the third surface 8c, a fifth surface 8e, and a sixth surface 8f facing the fifth surface 8e. The first surface 8a is a surface (mounting facing surface) facing the mounting substrate on which the coil device 1 is mounted.

In FIGS. 1 and 2 and the like, an X-axis is an axis parallel to a direction in which the third surface 8c and the fourth surface 8d face each other. A Y-axis is an axis parallel to a direction in which the fifth surface 8e and the sixth surface 8f face each other. A Z-axis is an axis perpendicular to the X-axis and the Y-axis. The Z-axis is an axis parallel to a winding axis of the wound portion 2. FIG. 2 illustrates the coil device 1 of FIG. 1 in an inverted state with respect to each of the X-axis and the Z-axis. Hereinafter, for each of the X-axis, the Y-axis, and the Z-axis, a direction toward a center of the coil device 1 is referred to as an inner side, and a direction away from the center of the coil device 1 is referred to as an outer side. For example, a length of the core 8 along the X-axis is 2 to 20 mm, a length along the Y-axis is 2 to 20 mm, and a length along the Z-axis is, 1 to 10 mm, for example.

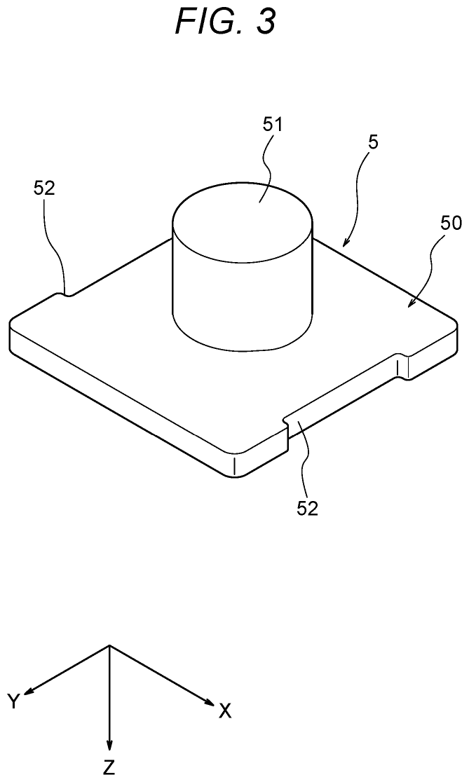

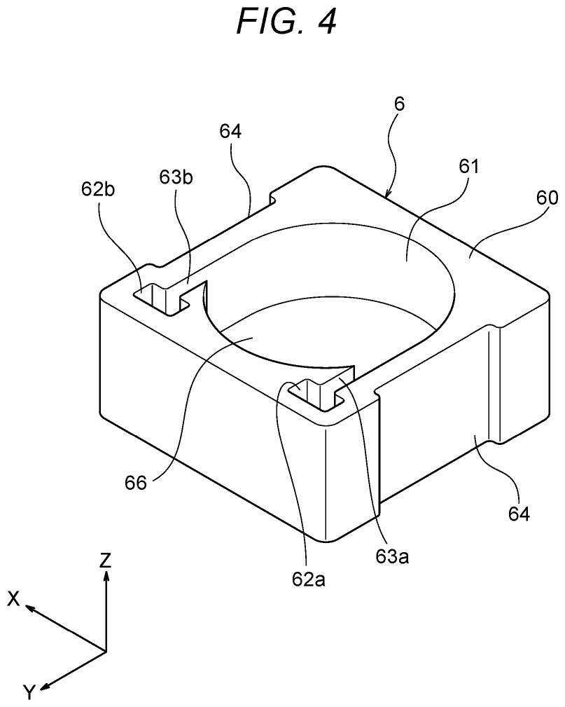

The core 8 is formed of a mixture including a magnetic powder and a binder resin, and is formed by combining a first core 5 illustrated in FIG. 3 and a second core 6 illustrated in FIG. 4. For example, the core 8 is formed by compression-molding the first core 5 and the second core 6, which are molded in advance, inside a mold and integrating them.

The core 8 (the first core 5 and/or the second core 6) is not particularly limited, but is made of a synthetic resin in which ferrite particles or metal magnetic particles are dispersed. The ferrite particles are not particularly limited, and examples thereof include Ni—Zn-based ferrite and Mn—Zn-based ferrite. The metal magnetic particles are not particularly limited, and examples thereof include Fe—Ni alloy powder, Fe—Si alloy powder, Fe—Si—Cr alloy powder, Fe—Co alloy powder, Fe—Si—Al alloy powder, and amorphous iron. The synthetic resin is not particularly limited, and examples thereof include an epoxy resin, a phenol resin, a polyester resin, a polyurethane resin, a polyimide resin, and a silicon resin.

As illustrated in FIG. 3, the first core 5 has a base portion 50 and a center core portion 51 protruding from the base portion 50. The center core portion 51 is disposed inside the wound portion 2 (FIG. 2). The first core 5 constitutes a part of the core 8 in the second surface 8b side illustrated in FIG. 2. The base portion 50 has a rectangular parallelepiped shape (plate shape). A recess 52 is formed on each side surface of the base portion 50 in the X-axis direction. The center core portion 51 is displaced toward a Y-axis negative direction side (the sixth surface 8f side in FIG. 2) with respect to the center of the base portion 50. Therefore, when the wound portion 2 is disposed on the center core portion 51, the winding axis of the wound portion 2 is displaced toward the sixth surface 8f along the Y-axis with respect to the center of the base portion 50.

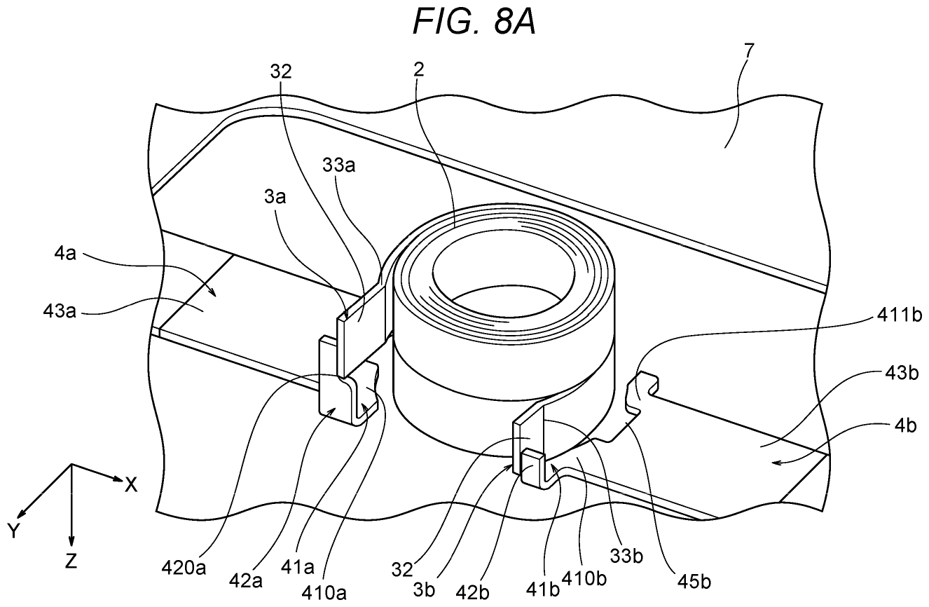

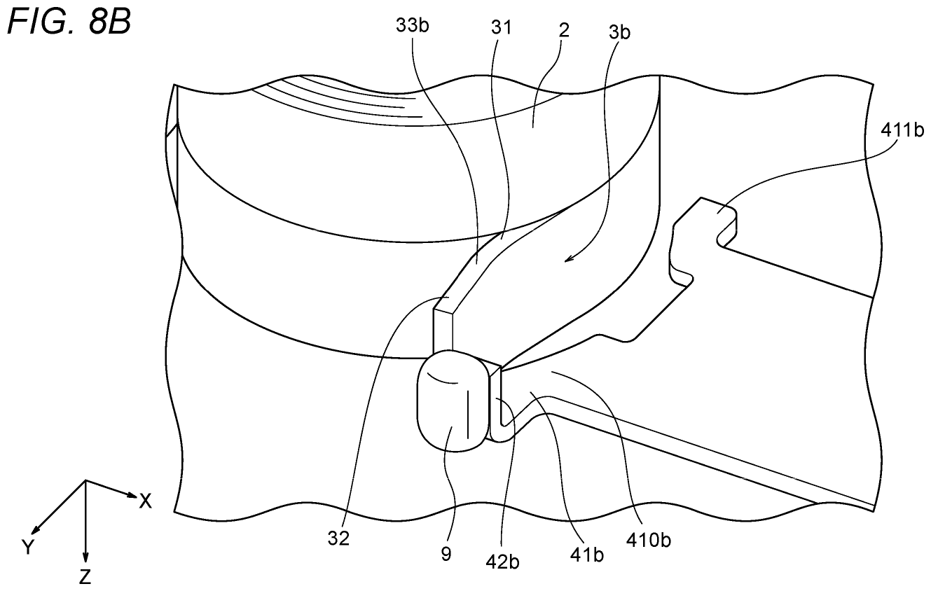

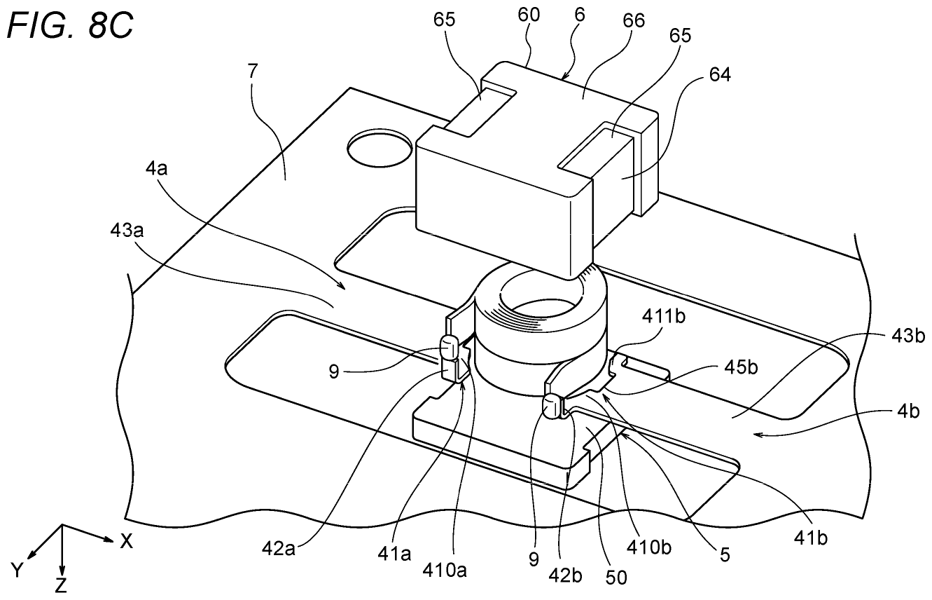

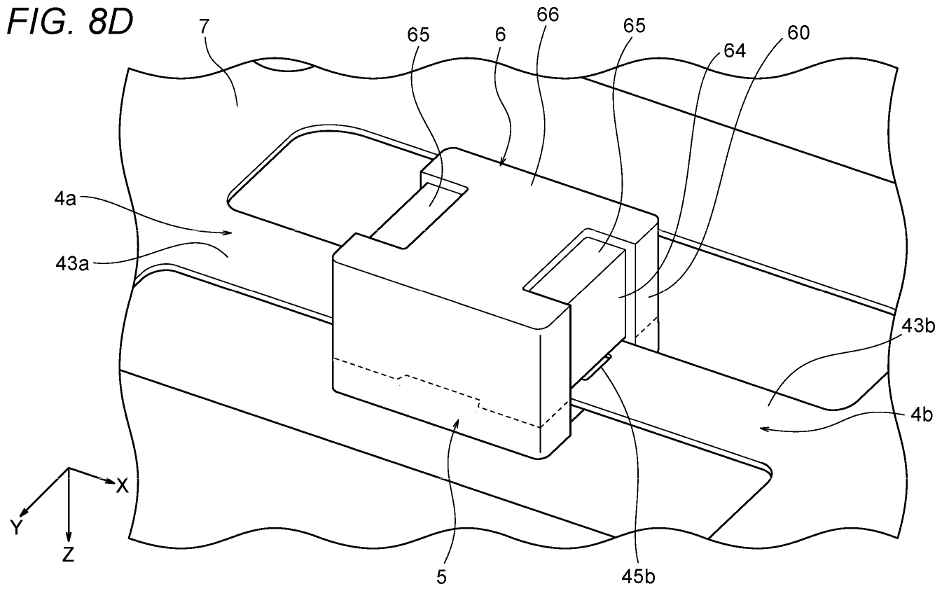

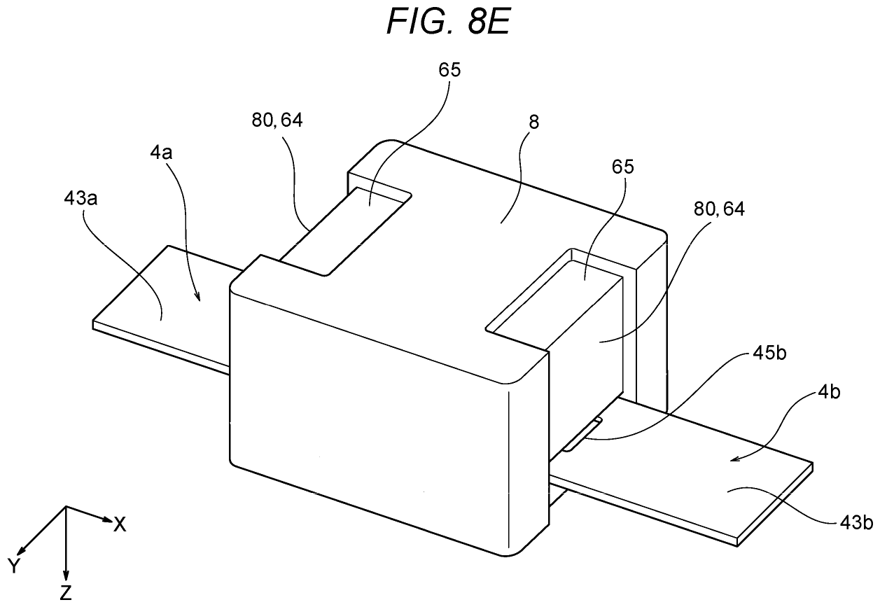

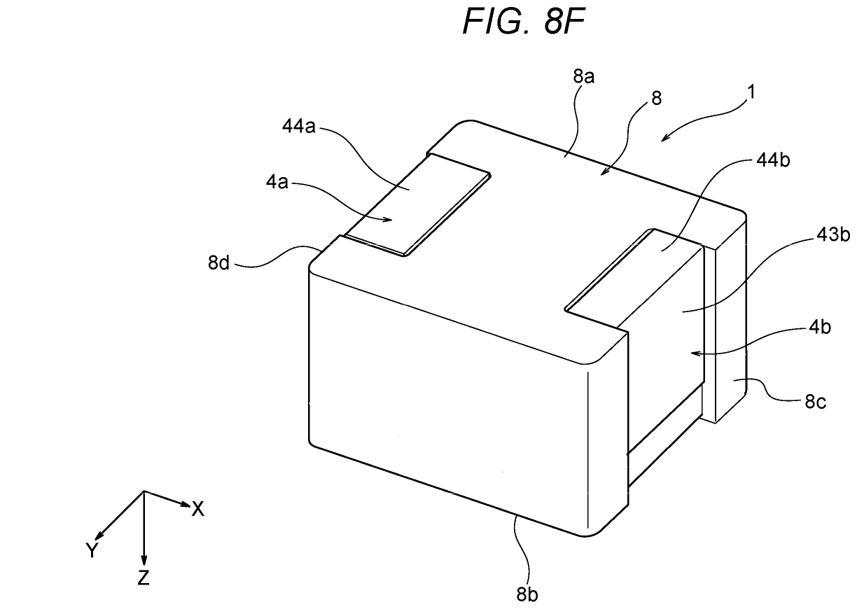

As illustrated in FIG. 4, the second core 6 has a cylindrical shape with a bottom. The second core 6 is combined with the first core 5 illustrated in FIG. 3 and integrated with the first core 5. The second core 6 may be made of the same material as that of the first core 5, or may be made of a different material. As illustrated in FIG. 4, the second core 6 has a main body portion 60, an accommodation hole 61, accommodation grooves 62a and 62b, connecting grooves 63a and 63b, a recess 64, a recess 65 (FIG. 8C), and a bottom portion 66. The second core 6 constitutes a part of the core 8 in the first surface 8a side illustrated in FIG. 2.

The main body portion 60 has a tubular shape. An outer edge of the main body portion 60 has a quadrangular shape in plan view. A length of the main body portion 60 along the X-axis is equal to a length of the base portion 50 (FIG. 3) along the X-axis, and a length of the main body portion 60 along the Y-axis is equal to a length of the base portion 50 along the Y-axis. The main body portion 60 (opening edge of the accommodation hole 61) is coupled to the base portion 50 (FIG. 3) and is integrated with the base portion 50.

The accommodation hole 61 extends along the Z-axis toward the bottom portion 66. The shape of the accommodation hole 61 is circular in plan view. One side of the accommodation hole 61 in the axial direction is opened, and the other side of the accommodation hole 61 in the axial direction is closed by the bottom portion 66. The center core portion 51 (FIG. 3) of the first core 5 and the wound portion 2 (FIG. 2) are accommodated in the accommodation hole 61.

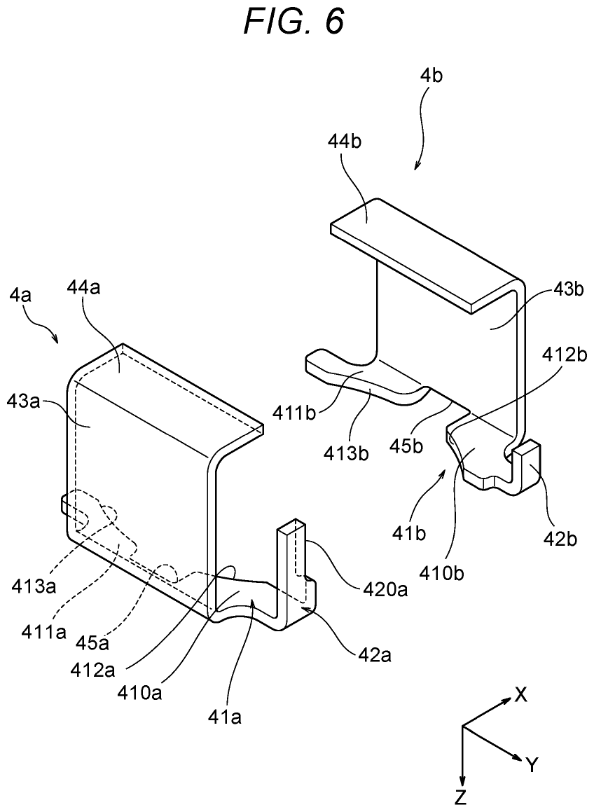

The bottom portion 66 is located on the side opposite to the opening surface of the accommodation hole 61 along the Z-axis. The bottom portion 66 forms the first surface 8a (FIG. 2) of the core 8. The recess 64 is formed on each side surface of the main body portion 60 in the X-axis direction, and extends from one end to the other end of each side surface in the Z-axis direction. As illustrated in FIGS. 4 and 6, an intermediate portion 43a of the terminal 4a is disposed in one recess 64, and an intermediate portion 43b of the terminal 4b is disposed in the other recess 64. As illustrated in FIGS. 3 and 4, a depth of the recess 64 along the X-axis is equal to a depth of the recess 52 along the X-axis. A length of the recess 64 along the Y-axis is equal to a length of the recess 52 along the Y-axis. When the second core 6 is combined with the first core 5, the recess 64 is coupled to the recess 52 along the Z-axis direction. Accordingly, as illustrated in FIG. 1, on each side surface of the core 8 in the X-axis direction, side recesses 80 are formed so as to extend from one end to the other end in the Z-axis direction.

As illustrated in FIG. 8C, the recess 65 is formed in the bottom portion 66. Two recesses 65 are formed in the bottom portion 66. One recess 65 is coupled to the recess 64 formed on one side surface of the main body portion 60 in the X-axis direction, and the other recess 65 is coupled to the recess 64 formed on the other side surface of the main body portion 60 in the X-axis direction.

As illustrated in FIG. 4, the accommodation grooves 62a and 62b are formed at respective corner portions on one side in the Y-axis direction. The accommodation grooves 62a and 62b are located radially outer side of the opening of the accommodation hole 61 and extend along the Z-axis toward the bottom portion 66. The wire connecting portion 42a (FIG. 2) is accommodated in the accommodation groove 62a. More specifically, the accommodation groove 62a accommodates the wire connecting portion 42a to which the leadout portion 3a is connected via a melted portion (molten ball) 9.

The wire connecting portion 42b (FIG. 2) is accommodated in the accommodation groove 62b. More specifically, the accommodation groove 62b accommodates the wire connecting portion 42b to which the leadout portion 3b is connected via the melted portion 9. The melted portion 9 is formed by irradiating the leadout portion 3a (3b) and the terminal 4a (4b) with a laser beam.

As illustrated in FIG. 4, the connecting grooves 63a and 63b extend along the Z-axis toward the bottom portion 66. The connecting groove 63a couples the accommodation hole 61 and the accommodation groove 62a, and the connecting groove 63b couples the accommodation hole 61 and the accommodation groove 62b. A part of the leadout portion 3a (FIG. 2) is accommodated in the connecting groove 63a, and a part of the leadout portion 3b is accommodated in the connecting groove 63b.

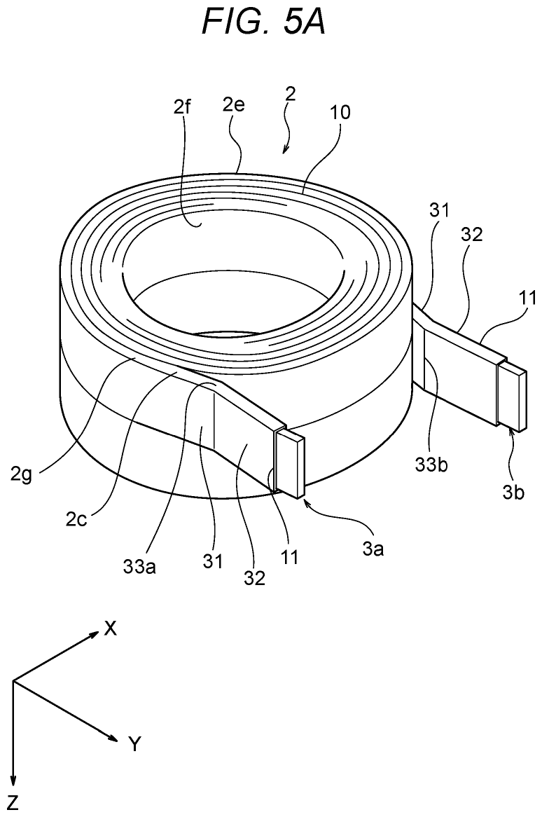

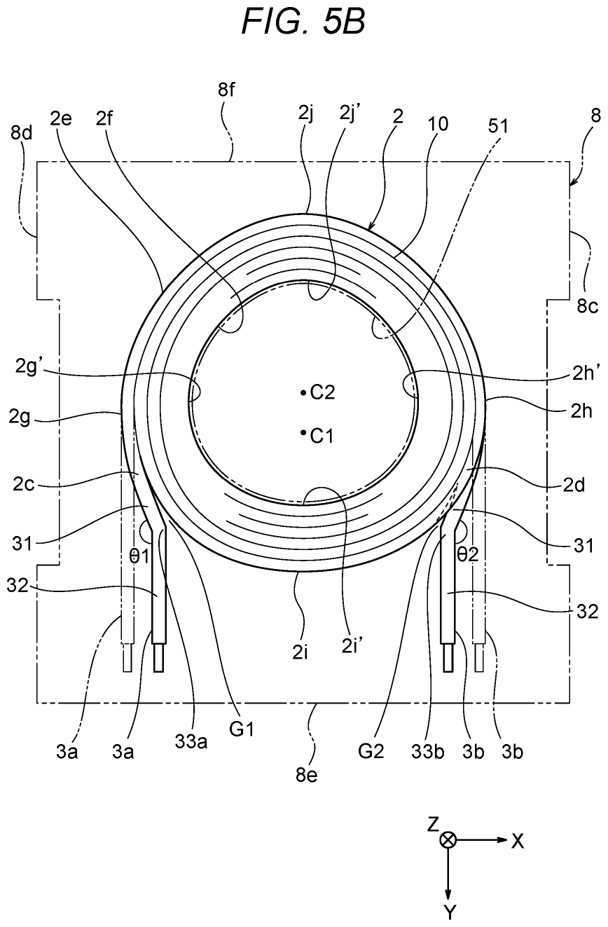

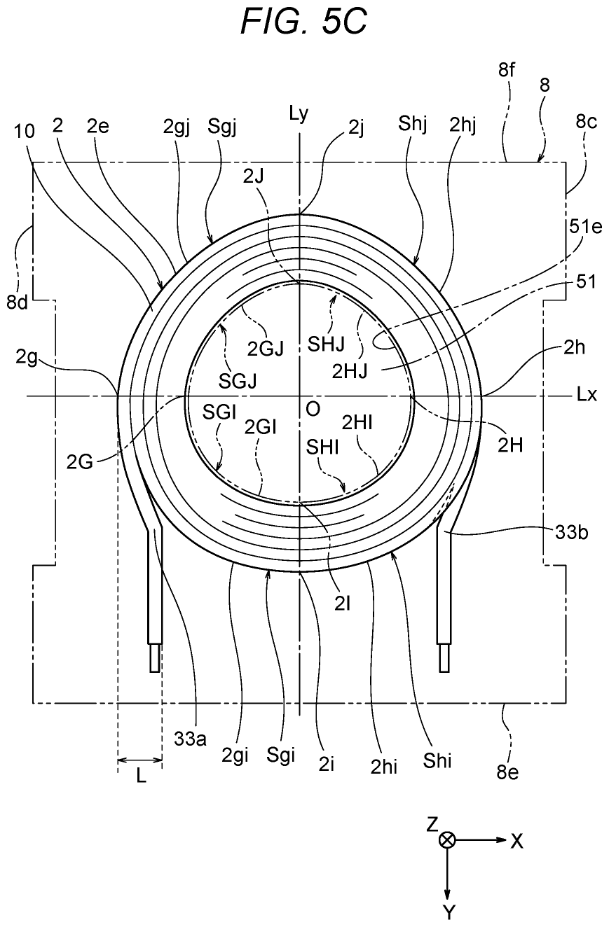

As illustrated in FIGS. 2 and 5A, the wound portion 2 is formed of an air-core coil and is embedded in the core 8. The wound portion 2 is formed by a spirally wound wire 10. The winding axis of the wound portion 2 is perpendicular to the first surface 8a of the element body. The wire 10 is a flat wire and is wound in a flatwise manner. However, the wire 10 may be edgewise wound. By configuring the wire 10 with a flat wire, it is possible to secure an amount of current flowing through the wound portion 2 and realize the coil device 1 having desired magnetic properties. In addition, it is possible to obtain the coil device 1 with high quality in which the wound portion 2 is hardly deformed.

The wound portion 2 is formed by, for example, α-winding the wire 10, and includes two layers along the Z-axis. However, the number of layers of the wound portion 2 along the Z-axis may be three or more. The winding method of the wire 10 is not limited to α-winding, and may be normal winding. The detailed shapes of the wound portion 2, the leadout portion 3a, and the leadout portion 3b will be described later.

As illustrated in FIG. 5B, a winding axis C2 of the wound portion 2 is displaced along the Y-axis with respect to a center C1 of the core 8. More specifically, the winding axis C2 of the wound portion 2 is displaced to one side (Y-axis negative direction side) opposite to a side where the leadout portions 3a and 3b are disposed (alternatively, leadout direction of leadout portions 3a and 3b: Y-axis positive direction side) with respect to the center C1 of the core 8.

A conductive part of the wire 10 is made of a metal such as copper, a copper alloy, silver, or nickel, or another conductor material. The wire 10 is an insulation-coated wire in which the conductive part is coated with an insulating coating film 11. A resin constituting the coating film 11 is not particularly limited, and is a polyamideimide resin, a urethane resin, or the like. The wire 10 may be a self-fusion wire, and a fusion layer may be formed on the outer side of the coating film 11 of the wire 10. A resin constituting the fusion layer is not particularly limited, and is a polyamide resin, an epoxy resin, or the like. The coating film 11 is removed at the tip of each of the leadout portions 3a and 3b. This is to achieve electrical coupling with the terminals 4a and 4b.

As illustrated in FIG. 2, the leadout portion 3a is led out from an outer circumferential surface 2e of the wound portion 2 toward the fifth surface 8e in the second layer of the wound portion 2. The leadout portion 3b is led out from the outer circumferential surface 2e of the wound portion 2 toward the fifth surface 8e in the first layer of the wound portion 2. The leadout portion 3a and the leadout portion 3b are displaced along the winding axis of the wound portion 2.

As illustrated in FIG. 6, the terminal 4a has a wire connecting portion 42a. The terminal 4a may further have, for example, a base portion 41a, an intermediate portion 43a, and a substrate connecting portion 44a. The terminal 4b has a wire connecting portion 42b. The terminal 4b may further have, for example, a base portion 41b, an intermediate portion 43b, and a substrate connecting portion 44b. The terminals 4a and 4b are formed of, for example, a plate having conductivity such as a metal.

As illustrated in FIGS. 2 and 6, the intermediate portion 43a extends along the Z-axis and is disposed in the side recess 80 (FIG. 1) formed in the fourth surface 8d of the core 8. One end of the intermediate portion 43a in the Z-axis direction is located at an intersection of the first surface 8a and the fourth surface 8d. The other end of the intermediate portion 43a in the Z-axis direction is located at a position separated from the intersection between the second surface 8b and the fourth surface 8d along the Z-axis.

The intermediate portion 43b extends along the Z-axis and is disposed in the side recess 80 (FIG. 1) formed in the third surface 8c of the core 8. One end of the intermediate portion 43b in the Z-axis direction is located at the intersection of the first surface 8a and the third surface 8c. The other end of the intermediate portion 43b in the Z-axis direction is located at a position separated from the intersection between the second surface 8b and the third surface 8c along the Z-axis.

A fillet such as solder or a conductive adhesive may be formed in the intermediate portions 43a and 43b. In this case, the mounting strength of the coil device 1 with respect to the mounting substrate can be increased.

The substrate connecting portion 44a is continuous to one end of the intermediate portion 43a in the Z-axis direction, and extends in a direction orthogonal to the intermediate portion 43a. The substrate connecting portion 44b is continuous to one end of the intermediate portion 43b in the Z-axis direction, and extends in a direction orthogonal to the intermediate portion 43b. The substrate connecting portions 44a and 44b are disposed on the first surface 8a and extend in directions approaching each other along the X-axis (inward in the X-axis direction). The substrate connecting portions 44a and 44b are configured to be connected to the mounting substrate by solder, a conductive adhesive, or the like.

The base portions 41a and 41b are disposed parallel to the second surface 8b of the core 8. The base portion 41a is continuous to the other end of the intermediate portion 43a in the Z-axis direction, and extends in a direction orthogonal to the intermediate portion 43a (the same direction as the extending direction of the substrate connecting portion 44a). The substrate connecting portion 44b is continuous to the other end of the intermediate portion 43b in the Z-axis direction, and extends in a direction orthogonal to the intermediate portion 43b (the same direction as the extending direction of the substrate connecting portion 44b). The base portions 41a and 41b each have a bifurcated shape, but the shape of the base portions 41a and 41b is not limited to the shape illustrated in FIG. 6.

As illustrated in FIGS. 2 and 6, the base portion 41a has a first branch portion 410a and a second branch portion 411a, and the base portion 41b has a first branch portion 410b and a second branch portion 411b. The first branch portion 410a and the second branch portion 411a are separated from each other in the Y-axis direction via a recess 45a. The first branch portion 410a has a curved shape, extends inward in the X-axis direction, and extends outward (toward the fifth surface 8e) in the Y-axis direction. The second branch portion 411a has a curved shape, extends inward in the X-axis direction, and extends outward (toward the sixth surface 8f) in the Y-axis direction. That is, the first branch portion 410a and the second branch portion 411a extend in directions away from each other in the Y-axis direction.

The first branch portion 410b and the second branch portion 411b are separated from each other in the Y-axis direction via a recess 45b. The first branch portion 410b has a curved shape, extends inward in the X-axis direction, and extends outward (toward the fifth surface 8e) in the Y-axis direction. The second branch portion 411b has a curved shape, extends inward in the X-axis direction, and extends outward (toward the sixth surface 8f) in the Y-axis direction. That is, the first branch portion 410b and the second branch portion 411b extend in directions away from each other in the Y-axis direction.

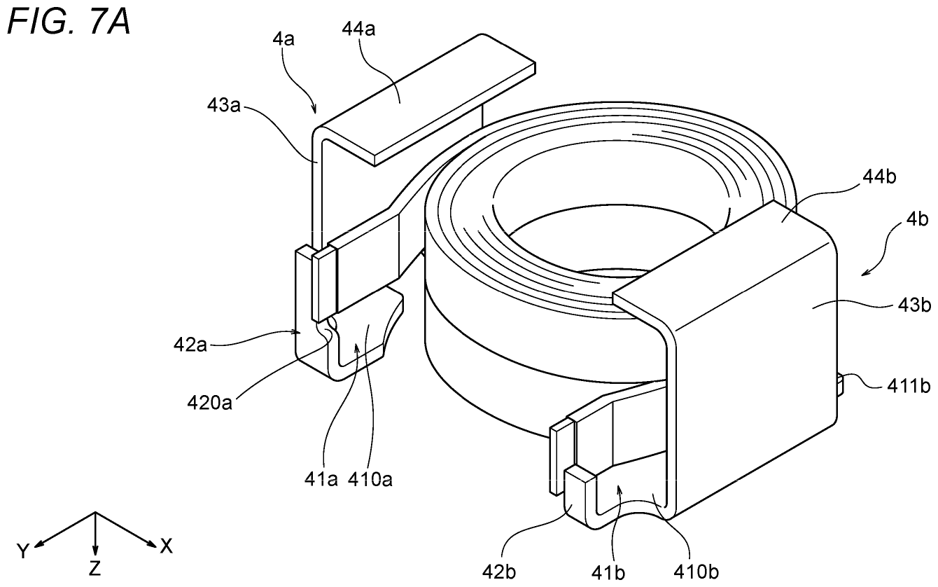

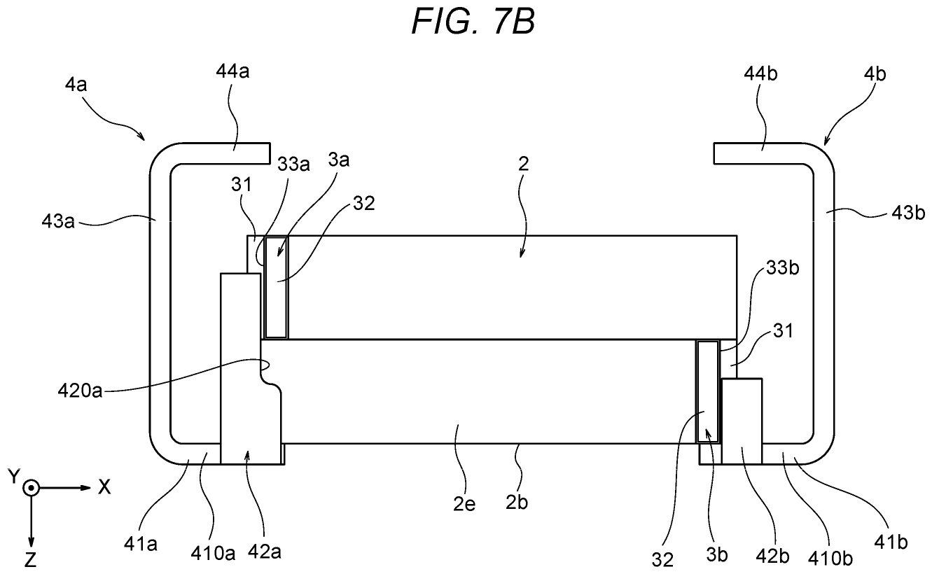

As illustrated in FIG. 7A, the leadout portion 3b is placed on the first branch portion 410b. Therefore, at the time of manufacturing the coil device 1 (at the time of compression molding of the first core 5 and the second core 6 illustrated in FIG. 8C), it is possible to prevent the displacement of the leadout portion 3b (further, the entire wound portion 2) due to the pressure. The leadout portion 3a is not placed on the first branch portion 410a, and is disposed at a position separated from the first branch portion 410a along the Z-axis.

As illustrated in FIGS. 2 and 6, a first curved portion 412a is partially formed at an inner edge portion of the first branch portion 410a, and a second curved portion 413a is partially formed at an inner edge portion of the second branch portion 411a. A first curved portion 412b is partially formed at an inner edge portion of the first branch portion 410b, and a second curved portion 413b is partially formed at an inner edge portion of the second branch portion 411b.

A radius of curvature of the first curved portion 412a, a radius of curvature of the second curved portion 413a, a radius of curvature of the first curved portion 412b, and a radius of curvature of the second curved portion 413b are equal to each other, but may be different from each other. These radii of curvature may be equal to the radius of curvature of the outer circumferential surface 2e or an inner circumferential surface 2f of the wound portion 2.

The wire connecting portions 42a and 42b are embedded inside the core 8. The wire connecting portion 42a extends along the Z-axis and is raised from an end portion of the first branch portion 410a in the Y-axis direction. The wire connecting portion 42b extends along the Z-axis and is raised from an end portion of the first branch portion 410b in the Y-axis direction. A cutout portion 420a is formed in the wire connecting portion 42a. The cutout portion 420a is located at an inner end portion of the wire connecting portion 42a in the X-axis direction, and extends from one end of the wire connecting portion 42a in the Z-axis direction toward the first branch portion 410a. As illustrated in FIG. 7A, the leadout portion 3a is disposed in the cutout portion 420a. The leadout portion 3b is disposed at an inner end portion of the wire connecting portion 42b in the X-axis direction.

A length of the wire connecting portion 42a along the Z-axis is longer than a length of the wire connecting portion 42b along the Z-axis. This is because the leadout portion 3a is led out from the second layer of the wound portion 2 to the wire connecting portion 42a without unnecessarily bending the leadout portion 3a.

As illustrated in FIG. 7B, the leadout portion 3a is disposed at a position separated from the bottom of the cutout portion 420a in the Z-axis direction, and is not in contact with the bottom of the cutout portion 420a. Therefore, the leadout portion 3a is not entirely accommodated in the cutout portion 420a, and protrudes from the cutout portion 420a along the Z-axis.

The leadout portions 3a and 3b are coupled to the wire connecting portions 42a and 42b by, for example, laser welding, soldering, a conductive adhesive, thermocompression bonding, ultrasonic waves bonding, resistance brazing, ultraviolet hardening resin bonding, or the like.

Next, the detailed shapes of the wound portion 2, the leadout portion 3a, and the leadout portion 3b will be described. In FIG. 5B, the outer shape of the core 8 is indicated by a two-dot chain line. In addition, the outer shape of the leadout portion 3a in the related art is indicated by a one-dot chain line. As indicated by the one-dot chain line in FIG. 5B, in the related art, the leadout portion 3a is led out along the Y-axis from an outermost end 2g of the outer circumferential surface 2e of the wound portion 2, and the leadout portion 3b is led out along the Y-axis from an outermost end 2h of the outer circumferential surface 2e of the wound portion 2. The outermost ends 2g and 2h are located at positions where the diameter of the outer circumferential surface 2e of the wound portion 2 is maximized as viewed from the Y-axis direction (as viewed from the fifth surface 8e of the core 8).

On the other hand, in the present embodiment, the leadout portion 3a is led out from a first leadout position 2c of the wound portion 2, and the leadout portion 3b is led out from a second leadout position 2d of the wound portion 2. The first leadout position 2c is a position where the leadout portion 3a starts to be separated from the outer circumferential surface 2e of the wound portion 2. The second leadout position 2d is a position where the leadout portion 3b starts to be separated from the outer circumferential surface 2e of the wound portion 2.

That is, in the present embodiment, the wire 10 is wound at least from the outermost end 2g to the first leadout position 2c along the circumferential direction of the wound portion 2. The wire 10 is wound at least from the outermost end 2h to the second leadout position 2d along the circumferential direction of the wound portion 2. Therefore, the number of turns of the wound portion 2 can be increased as compared with the related art.

The leadout portion 3a has a bent portion 33a, and the leadout portion 3b has a bent portion 33b. The bent portions 33a and 33b are disposed so as to be adjacent to the outer circumferential surface 2e. In the Y-axis direction, a position of the bent portion 33a and a position of the bent portion 33b are equal to each other. However, the position of the bent portion 33a and the position of the bent portion 33b may be different in the Y-axis direction.

Each of the bent portions 33a and 33b is bent so as to protrude inward in the X-axis direction. That is, the bent portions 33a and 33b are bent in directions approaching each other. The bent portions 33a and 33b are bent so as to protrude toward the outer circumferential surface 2e of the wound portion 2 (so as to approach the outer circumferential surface 2e of the wound portion 2). The bent portion 33a is bent so as to protrude toward the inner side of the leadout portion 3a, and the bent portion 33b is bent so as to protrude toward the inner side of the leadout portion 3b. The bent portion 33a is bent such that the outer side of the leadout portion 3a is recessed, and the bent portion 33b is bent such that the outer side of the leadout portion 3b is recessed.

In FIG. 5B, for convenience of explanation, the bent portions 33a and 33b are bent so as to be angular. However, the bent portions 33a and 33b may be bent smoothly (so as to be curved).

The bent portion 33a is located inside (X-axis positive direction side) the outermost end 2g of the outer circumferential surface 2e in the X-axis direction. The bent portion 33a is located outside (X-axis negative direction side) an outermost end 2g′ of the inner circumferential surface 2f in the X-axis direction. Similarly, the bent portion 33b is located inside (X-axis negative direction side) the outermost end 2h of the outer circumferential surface 2e in the X-axis direction. The bent portion 33b is located outside (X-axis positive direction side) an outermost end 2h′ of the inner circumferential surface 2f in the X-axis direction. However, the positions of the bent portions 33a and 33b are not limited to the above positions, and may be located inside the outermost ends 2g′ and 2h′ in the Y-axis direction, for example. The outermost ends 2g′ and 2h′ are located at positions where the diameter of the inner circumferential surface 2f of the wound portion 2 is maximized as viewed from the Y-axis direction (as viewed from the fifth surface 8e of the core 8).

The bent portions 33a and 33b are located inside (Y-axis negative direction side) a most distal end 2i of the outer circumferential surface 2e of the wound portion 2 in the Y-axis direction. The most distal end 2i is located at a position where the diameter of the outer circumferential surface 2e of the wound portion 2 is maximized as viewed from the X-axis direction (as viewed from the fourth surface 8d of the core 8). Further, the bent portions 33a and 33b are located outside (Y-axis positive direction side) a most distal end 2i′ in the Y-axis direction. The most distal end 2i′ is located at a position where the diameter of the inner circumferential surface 2f of the wound portion 2 is maximized as viewed from the X-axis direction (as viewed from the fourth surface 8d of the core 8). The bent portions 33a and 33b are located outside (Y-axis positive direction side) the first leadout position 2c or the second leadout position 2d in the Y-axis direction. However, the positions of the bent portions 33a and 33b are not limited to the above positions, and may be located outside the most distal end 2i in the Y-axis direction, for example.

As illustrated in FIG. 5C, a length L along the X-axis between the bent portion 33a and the outermost end 2g of the outer circumferential surface 2e is not particularly limited, but is ½ times or more, 1 time or more, 2 times or more, 3 times or more, or 5 times or more a diameter of the wire 10. The same applies to the length along the X-axis between the bent portion 33b and the outermost end 2h of the outer circumferential surface 2e.

As illustrated in FIG. 5B, the leadout portion 3a is bent at the bent portion 33a and then extends along the Y-axis toward the fifth surface 8e. After being bent at the bent portion 33b, the leadout portion 3b extends along the Y-axis toward the fifth surface 8e. However, as described later, the leadout portion 3a may extend along a direction inclined with respect to the Y-axis toward the fifth surface 8e after being bent at the bent portion 33a. Further, the leadout portion 3b may extend along a direction inclined with respect to the Y-axis toward the fifth surface 8e after being bent at a bent portion 34b.

In the present embodiment, the bent portion 33a and the outer circumferential surface 2e of the wound portion 2 are separated from each other. Therefore, the leadout portion 3a is bent at a position separated from the outer circumferential surface 2e, and then extends along the Y-axis (alternatively, along a direction inclined with respect to the Y-axis) toward the fifth surface 8e. The bent portion 33b and the outer circumferential surface 2e are separated from each other. Therefore, the leadout portion 3b is bent at a position separated from the outer circumferential surface 2e, and then extends along the Y-axis (alternatively, along a direction inclined with respect to the Y-axis) toward the fifth surface 8e.

An inner angle θ1 of the bent portion 33a is an obtuse angle, and 90°<θ1<180°. Further, an inner angle θ2 of the bent portion 33b is an obtuse angle, and 90°<θ2<180°. However, the inner angle θ1 of the bent portion 33a may be 120°<θ1<170° or 130°<θ1<170°. The inner angle θ2 of the bent portion 33b may be 120°<θ2<170° or 130°<θ2<170°. The inner angle θ1 of the bent portion 33a and the inner angle θ2 of the bent portion 33b are inner angles formed by a proximal end portion 31 and a distal end portion 32 described later, respectively. When the bent portions 33a and 33b are smoothly curved, the inner angles θ1 and θ2 are defined as inner angles formed by a virtual extension line of the proximal end portion 31 and a virtual extension line of the distal end portion 32, respectively. The inner angles θ1 and θ2 are equal, but may be different.

An interval along the X-axis between the bent portion 33a and the bent portion 33b is smaller than the maximum diameter of the wound portion 2 (outer circumferential surface 2e) as viewed from the fifth surface 8e side. That is, the interval along the X-axis between the bent portion 33a and the bent portion 33b is smaller than an interval along the X-axis between the outermost end 2g and the outermost end 2h of the outer circumferential surface 2e.

The interval along the X-axis between the bent portion 33a and the bent portion 33b is larger than the maximum diameter of the inner circumferential surface 2f as viewed from the fifth surface 8e side. That is, the interval along the X-axis between the bent portion 33a and the bent portion 33b is larger than an interval along the X-axis between the outermost end 2g′ and the outermost end 2h′ of the inner circumferential surface 2f. However, the interval along the X-axis between the bent portion 33a and the bent portion 33b may be smaller than the maximum diameter of the inner circumferential surface 2f as viewed from the fifth surface 8e side.

A distance between the bent portion 33a and the outer circumferential surface 2e is smaller than the diameter of the wire 10 or may be smaller than ½ of the diameter of the wire 10. However, the distance between the bent portion 33a and the outer circumferential surface 2e may be equal to the diameter of the wire 10 or may be larger than the diameter of the wire 10. The same applies to a distance between the bent portion 33b and the outer circumferential surface 2e.

The bent portion 33a and the outer circumferential surface 2e may not be separated from each other. In this case, the leadout portion 3a extends along the Y-axis (alternatively, along a direction inclined with respect to the Y-axis) toward the fifth surface 8e while being bent with respect to the outer circumferential surface 2e at the bent portion 33a on the outer circumferential surface 2e.

Further, the bent portion 33b and the outer circumferential surface 2e may not be separated from each other. In this case, the leadout portion 3b extends along the Y-axis (alternatively, along a direction inclined with respect to the Y-axis) toward the fifth surface 8e while being bent with respect to the outer circumferential surface 2e at the bent portion 33b on the outer circumferential surface 2e.

A space G1 is formed between the leadout portion 3a (a proximal end portion 31 described later) and the outer circumferential surface 2e of the wound portion 2. The space G1 extends from the vicinity of the bent portion 33a toward the first leadout position 2c. The space G1 extends along the outer circumferential surface 2e, and a width of the space G1 becomes narrower toward the first leadout position 2c. A maximum width of the space G1 corresponds to the distance between the bent portion 33a and the outer circumferential surface 2e described above.

Similarly, a space G2 is formed between the leadout portion 3b (a proximal end portion 31 described later) and the outer circumferential surface 2e of the wound portion 2. The space G2 extends from the vicinity of the bent portion 33b toward the second leadout position 2d. The space G2 extends along the outer circumferential surface 2e, and a width of the space G2 becomes narrower toward the second leadout position 2d. A maximum width of the space G2 corresponds to the distance between the bent portion 33b and the outer circumferential surface 2e described above.

The leadout portion 3a has a proximal end portion 31 located on one side of the bent portion 33a and a distal end portion 32 located on the other side of the bent portion 33a. In addition, the leadout portion 3b has a proximal end portion 31 located on one side of the bent portion 33b and a distal end portion 32 located on the other side of the bent portion 33b.

The proximal end portion 31 extends along the outer circumferential surface 2e of the wound portion 2, and is disposed in the vicinity of the outer circumferential surface 2e of the wound portion 2 than the distal end portion 32. In the leadout portion 3a, the proximal end portion 31 is a portion located between the first leadout position 2c and the bent portion 33a. In the leadout portion 3b, the proximal end portion 31 is a portion located between the second leadout position 2d and the bent portion 33b. The extending direction of the proximal end portion 31 is equal to the tangential direction at the first leadout position 2c (or the second leadout position 2d), but may be different. For example, the proximal end portion 31 may be led out in a direction inclined outward (side away from the center of the wound portion 2) with respect to the tangential direction at the first leadout position 2c (or the second leadout position 2d). The space G1 or G2 is formed between the proximal end portion 31 and the outer circumferential surface 2e of the wound portion 2, and the space G1 or G2 is formed along the proximal end portion 31 and the outer circumferential surface 2e.

The distal end portion 32 extends in a direction different from the proximal end portion 31 so as to be separated from the outer circumferential surface 2e of the wound portion 2. The distal end portion 32 is disposed at a position farther away from the outer circumferential surface 2e of the wound portion 2 than the proximal end portion 31. The distal end portion 32 extends along the Y-axis toward the fifth surface 8e, but may extend in a direction inclined with respect to the Y-axis. A length of the distal end portion 32 along the extending direction is longer than the length of the proximal end portion 31 along the extending direction, but may be equal to or shorter than this.

An interval between the distal end portion 32 of the leadout portion 3a and the distal end portion 32 of the leadout portion 3b is smaller than a maximum diameter of the wound portion 2 (outer circumferential surface 2e) as viewed from the fifth surface 8e side. That is, the interval along the X-axis between the distal end portion 32 of the leadout portion 3a and the distal end portion 32 of the leadout portion 3b is smaller than an interval along the X-axis between the outermost end 2g and the outermost end 2h of the outer circumferential surface 2e. However, the interval between the distal end portion 32 of the leadout portion 3a and the distal end portion 32 of the leadout portion 3b may be partially larger than the maximum diameter of the wound portion 2 as viewed from the fifth surface 8e side.

The interval between the distal end portion 32 of the leadout portion 3a and the distal end portion 32 of the leadout portion 3b is larger than the maximum diameter of the inner circumferential surface 2f as viewed from the fifth surface 8e side. That is, the interval along the X-axis between the distal end portion 32 of the leadout portion 3a and the distal end portion 32 of the leadout portion 3b is larger than an interval along the X-axis between the outermost end 2g′ and the outermost end 2h′ of the inner circumferential surface 2f. However, the interval between the distal end portion 32 of the leadout portion 3a and the distal end portion 32 of the leadout portion 3b may be smaller than the maximum diameter of the inner circumferential surface 2f as viewed from the fifth surface 8e side.

As described above, the space G1 or G2 is formed between the proximal end portion 31 and the outer circumferential surface 2e. However, the space G1 or G2 may be omitted. When the space G1 or G2 is omitted, the proximal end portion 31 extends so as to be adjacent to the outer circumferential surface 2e (so as to be in contact with the outer circumferential surface 2e) along the circumferential direction of the wound portion 2. Therefore, the proximal end portion 31 constitutes a part of the wound portion 2. As described above, as a result of the proximal end portion 31 being absorbed by the wound portion 2, the proximal end portion 31 is omitted from the leadout portion 3a, and the proximal end portion 31 is omitted from the leadout portion 3b.

In this case, the distal end portion 32 extends from the outer circumferential surface 2e toward the fifth surface 8e along the Y-axis (alternatively, along a direction inclined with respect to the Y-axis). Also in this case, since the distal end portion 32 is bent with respect to the outer circumferential surface 2e, the bent portion 33a or 33b is formed on the outer circumferential surface 2e. Since the distal end portion 32 of the leadout portion 3a is separated from the outer circumferential surface 2e at the bent portion 33a on the outer circumferential surface 2e, the position of the bent portion 33a becomes the first leadout position 2c. In addition, since the distal end portion 32 of the leadout portion 3b is separated from the outer circumferential surface 2e at the bent portion 33b on the outer circumferential surface 2e, the position of the bent portion 33b becomes the second leadout position 2d.

As illustrated in FIG. 5C, the shape of the outer circumferential surface 2e of the wound portion 2 is different between the Y-axis positive direction side (first direction side: side from which the leadout portions 3a and 3b are led out) and the Y-axis negative direction side (second direction side). The outer circumferential surface 2e of the wound portion 2 is distorted so as to bulge outward from the outer circumferential surface 2e of the wound portion 2 toward the Y-axis positive direction. The outer circumferential surface 2e of the wound portion 2 is distorted so as to be convex (pointed) toward the Y-axis negative direction. That is, the outer circumferential surface 2e does not have a perfect circular shape and is distorted to have a triangular shape.

The outer circumferential surface 2e of the wound portion 2 is gently (flatly) curved in the vicinity of a most distal end 2i as compared with the vicinity of a most proximal end 2j. Further, the outer circumferential surface 2e of the wound portion 2 is curved more steeply (convexly) in the vicinity of the most proximal end 2j as compared with the vicinity of the most distal end 2i. The most proximal end 2j is located at a position where the diameter of the outer circumferential surface 2e of the wound portion 2 is maximized as viewed from the X-axis direction (as viewed from the fourth surface 8d of the core 8).

The shape of the inner circumferential surface 2f of the wound portion 2 is different between the Y-axis positive direction side (first direction side) and the Y-axis negative direction side (second direction side). The inner circumferential surface 2f of the wound portion 2 is distorted so as to bulge outward from the inner circumferential surface 2f of the wound portion 2 toward the Y-axis positive direction. The inner circumferential surface 2f of the wound portion 2 is distorted so as to be convex toward the Y-axis negative direction. That is, similarly to the outer circumferential surface 2e, the inner circumferential surface 2f does not have a perfect circular shape and is distorted to have a triangular shape.

Here, a section from the outermost end 2g to the most proximal end 2j in the outer circumferential surface 2e is defined as 2gj. A section from the outermost end 2g to the most distal end 2i in the outer circumferential surface 2e is defined as 2gi. A section from the outermost end 2h to the most proximal end 2j in the outer circumferential surface 2e is defined as 2hj. A section from the outermost end 2h to the most distal end 2i in the outer circumferential surface 2e is defined as 2hi.

In the present embodiment, a radius of curvature of the outer circumferential surface 2e in the section 2gj is smaller than a radius of curvature of the outer circumferential surface 2e in the section 2gi. A radius of curvature of the outer circumferential surface 2e in the section 2hj is smaller than a radius of curvature of the outer circumferential surface 2e in the section 2hi. This is because a degree of curvature of the outer circumferential surface 2e on the Y-axis positive direction side is smaller than a degree of curvature of the outer circumferential surface 2e on the Y-axis negative direction side.

The radius of curvature of the outer circumferential surface 2e in the section 2gj is equal to the radius of curvature of the outer circumferential surface 2e in the section 2hj. However, these radii of curvature may be different. The radius of curvature of the outer circumferential surface 2e in the section 2gi is equal to the radius of curvature of the outer circumferential surface 2e in the section 2hi. However, these radii of curvature may be different.

Here, as illustrated in FIG. 5C, a straight line Lx and a straight line Ly are set, and an intersection of the straight line Lx and the straight line Ly is defined as O. The straight line Lx is a straight line parallel to the X-axis, and the straight line Ly is a straight line parallel to the Y-axis. A length between the intersection O and the outermost end 2g of the outer circumferential surface 2e is equal to a length between the intersection O and the outermost end 2h of the outer circumferential surface 2e. A length between the intersection O and the most distal end 2i of the outer circumferential surface 2e is equal to a length between the intersection O and the most proximal end 2j of the outer circumferential surface 2e.

When a section surrounded by the straight line Lx, the straight line Ly, and the outer circumferential surface 2e in the section 2hj is defined as a section Shj, and a section surrounded by the straight line Lx, the straight line Ly, and the outer circumferential surface 2e in the section 2hi is defined as a section Shj, an area of the section Shj is smaller than an area of the section Shi. A section surrounded by the straight line Lx, the straight line Ly, and the outer circumferential surface 2e in the section 2gj is defined as a section Sgj. A section surrounded by the straight line Lx, the straight line Ly, and the outer circumferential surface 2e in the section 2gi is defined as a section Sgi. An area of the section Sgj is smaller than an area of the section Sgi. This is because the outer circumferential surface 2e of the wound portion 2 is distorted so as to be convex toward the Y-axis negative direction side.

The wound portion 2 having such a shape is formed, for example, by pressing the outer circumferential surface 2e (in particular, the sections 2hj and 2gj) of the wound portion 2 having a perfect circular shape radially inward (toward the center of the wound portion 2) on the Y-axis negative direction side. In addition, it is formed by pressing the inner circumferential surface 2f of the wound portion 2 having a perfect circular shape radially outward on the Y-axis positive direction side.

A shape of an outer circumferential surface 51e of the center core portion 51 in the Y-axis positive direction (first direction side) is different from the shape of the outer circumferential surface 51e of the center core portion 51 in the Y-axis negative direction (second direction side). The outer circumferential surface 51e of center core portion 51 is distorted so as to bulge outward from the outer circumferential surface 51e of center core portion 51 toward the Y-axis positive direction. The outer circumferential surface 51e of center core portion 51 is distorted so as to be convex toward the Y-axis negative direction. That is, the outer circumferential surface 51e of the center core portion 51 does not have a perfect circular shape, and is distorted to have a triangular shape.

The outer circumferential surface 51e of the center core portion 51 is gently (flatly) curved in the vicinity of a most distal end 2I as compared with the vicinity of a most proximal end 2J. Further, the outer circumferential surface 51e of the center core portion 51 is curved steeply (convexly) in the vicinity of the most proximal end 2J as compared with the vicinity of the most distal end 2I. The most distal end 2I and the most proximal end 2J are located at positions where the diameter of the center core portion 51 is maximized as viewed from the X-axis direction (as viewed from the fourth surface 8d of the core 8).

Here, a section from an outermost end 2G to the most proximal end 2J in the outer circumferential surface 51e is defined as 2GJ. A section from the outermost end 2G to the most distal end 2I in the outer circumferential surface 51e is defined as 2GI. A section from an outermost end 2H to the most proximal end 2J in the outer circumferential surface 51e is defined as 2HJ. A section from the outermost end 2H to the most distal end 2I in the outer circumferential surface 51e is defined as 2HI. The outermost ends 2G and 2H are located at positions where the diameter of the outer circumferential surface 51e of the center core portion 51 is maximized as viewed from the Y-axis direction (as viewed from the fifth surface 8e of the core 8).

In the present embodiment, a radius of curvature of the outer circumferential surface 51e in the section 2GJ is smaller than a radius of curvature of the outer circumferential surface 51e in the section 2GI. A radius of curvature of the outer circumferential surface 51e in the section 2HJ is smaller than a radius of curvature of the outer circumferential surface 51e in the section 2HI. This is because a degree of curvature of the outer circumferential surface 51e on the Y-axis positive direction is smaller than a degree of curvature of the outer circumferential surface 51e on the Y-axis negative direction.

The radius of curvature of the outer circumferential surface 51e in the section 2GJ is equal to the radius of curvature of the outer circumferential surface 51e in the section 2HJ. However, these radii of curvature may be different. The radius of curvature of the outer circumferential surface 51e in the section 2GI is equal to the radius of curvature of the outer circumferential surface 51e in the section 2HI. However, these radii of curvature may be different.

A section surrounded by the straight line Lx, the straight line Ly, and the outer circumferential surface 51e in the section 2HJ is defined as a section SHJ. A section surrounded by the straight line Lx, the straight line Ly, and the outer circumferential surface 51e in the section 2HI is defined as a section SHI. An area of the section SHJ is smaller than an area of the section SHI. A section surrounded by the straight line Lx, the straight line Ly, and the outer circumferential surface 51e in the section 2GJ is defined as a section SGJ. A section surrounded by the straight line Lx, the straight line Ly, and the outer circumferential surface 51e in the section 2GI is defined as a section SGI. An area of the section SGJ is smaller than an area of the section SGI. This is because the outer circumferential surface 51e of center core portion 51 is distorted so as to be convex toward the Y-axis negative direction.

The center core portion 51 having such a shape is formed by molding the center core portion 51 such that a cross-sectional shape of the center core portion 51 of the first core 5 illustrated in FIG. 3 is a cross-sectional shape illustrated in FIG. 5C. In addition, for example, at the time of compression molding of the core 8 (the first core 5 illustrated in FIG. 3 and the second core 6 illustrated in FIG. 4), by using a density difference of the magnetic material constituting the core 8 (the first core 5 illustrated in FIG. 3 and the second core 6 illustrated in FIG. 4), it is possible to form the center core portion 51 having the shape illustrated in FIG. 5C. In the present embodiment, the density of the core 8 (the first core 5 illustrated in FIG. 3 and the second core 6 illustrated in FIG. 4) on the Y-axis negative direction is larger than the density of the core 8 on the Y-axis positive direction.

Next, a method of manufacturing the coil device 1 will be described with reference to FIGS. 8A to 8F. First, a conductive plate with a Sn-plating is punched into a shape illustrated in FIG. 8A or FIG. 8C. Thus, the punched conductive plate is provided with the terminals 4a and 4b and a frame 7.

Next, the wound portion 2 is disposed between the terminal 4a and the terminal 4b. Further, the distal end portion 32 of the leadout portion 3a is disposed in the cutout portion 420a of the wire connecting portion 42a, and the distal end portion 32 of the leadout portion 3b is disposed on the first branch portion 410b of the base portion 41b. As the wound portion 2, a wound portion having a perfect circular shape in plan view is used instead of a wound portion having a distorted shape as illustrated in FIG. 5B. In addition, the bent portion 33a is formed in advance in the leadout portion 3a, and the bent portion 33b is formed in advance in the leadout portion 3b.

Next, as illustrated in FIG. 8B, the wire connecting portion 42b is irradiated with a laser beam, and the leadout portion 3b (distal end portion 32) is integrated with the wire connecting portion 42b via the melted portion 9. The wire connecting portion 42a is irradiated with a laser beam, and the leadout portion 3a (distal end portion 32) is integrated with the wire connecting portion 42a via the melted portion 9 (see FIG. 2). In the present embodiment, since the leadout portions 3a and 3b are led out in the same direction, laser irradiation can be performed on the leadout portions 3a and 3b from the same direction, and laser welding is easy.

Next, the wound portion 2 is installed in a mold together with the terminals 4a and 4b. Then, as illustrated in FIG. 8C, the wound portion 2 is disposed on the center core portion 51 (FIG. 3) of the first core 5, and the second core 6 is disposed on the base portion 50 of the first core 5 so as to cover the wound portion 2. Then, as illustrated in FIG. 8D, an assembly of the first core 5 and the second core 6 is formed. The intermediate portion 43a and the intermediate portion 43b are exposed from the first core 5 and the second core 6. As the first core 5 and the second core 6, cores (temporary molding cores) molded in advance are used. As a material constituting the first core 5 and the second core 6, a flowable material is used, and a composite magnetic material using a thermoplastic resin or a thermosetting resin as a binder is used.

Next, the first core 5 and the second core 6 are integrated by compression molding the assembly illustrated in FIG. 8D to form a core 8 (FIG. 8E). At this time, a distorted shape (bulging shape and convex shape) as illustrated in FIG. 5B can be imparted to the outer circumferential surface 51e of the center core portion 51 by a density difference (density deviation) between the magnetic materials constituting each of the first core 5 and the second core 6. In addition, a distorted shape (bulging shape and convex shape) as illustrated in FIG. 5B can be imparted to the outer circumferential surface 2e of the wound portion 2 by the pressure during the compression molding (pressure received from the center core portion 51 of the first core 5/pressure received from the main body portion 60 of the second core 6). For example, the density of the magnetic material constituting the second core 6 may be made lower toward the peripheral portions of the wire connecting portions 42a and 42b.

Next, as illustrated in FIG. 8E, the frame 7 (FIG. 8D) is cut and removed with a cutting device. Next, as illustrated in FIG. 8F, the intermediate portion 43a is bent and fixed to the fourth surface 8d (side recess 80) of the core 8. Further, the distal end portion of the intermediate portion 43a is bent and disposed on the first surface 8a of the core 8 to form the substrate connecting portion 44a. The intermediate portion 43b is bent and disposed on the third surface 8c (side recess 80) of the core 8. Further, the distal end portion of the intermediate portion 43b is bent and disposed on the first surface 8a of the core 8 to form the substrate connecting portion 44b. The coil device 1 can be manufactured as described above.

As illustrated in FIG. 5B, in the coil device 1 of the present embodiment, the leadout portion 3a has a bent portion 33a bent so as to protrude inward when viewed along the winding axis. Therefore, depending on a bending degree of the bent portion 33a, a part of the leadout portion 3a is disposed in the vicinity of the outer circumferential surface 2e of the wound portion 2, and the space G1 is hardly formed between the leadout portion 3a and the outer circumferential surface 2e. Therefore, at the time of manufacturing the coil device 1, the magnetic material constituting the core 8 is less likely to enter between the leadout portion 3a and the outer circumferential surface 2e. This makes it possible to prevent a short circuit failure between the leadout portion 3a and the outer circumferential surface 2e via the magnetic material. In addition, since a part of the leadout portion 3a is disposed in the vicinity of the outer circumferential surface 2e, the number of turns of the wound portion 2 can be increased, and the magnetic properties (inductance value) of the coil device 1 can be improved. In addition, since the inner angle θ1 of the bent portion 33a is an obtuse angle, the leadout portion 3a is not excessively bent at the bent portion 33a, and it is possible to prevent a variation in the electrical properties of the coil device 1 due to the bending of the leadout portion 3a.

The bent portion 33a is adjacent to the outer circumferential surface 2e of the wound portion 2. Therefore, a part of the leadout portion 3a is disposed in the vicinity of the outer circumferential surface 2e of the wound portion 2, and the space G1 is hardly formed between the leadout portion 3a and the outer circumferential surface 2e. Therefore, the above-described effect can be effectively obtained.

In addition, the leadout portion 3a has a proximal end portion 31 located on one side of the bent portion 33a and a distal end portion 32 located on the other side of the bent portion 33a. The proximal end portion 31 is closer to the outer circumferential surface 2e of the wound portion 2 than the distal end portion 32. Since the proximal end portion 31 is closer to the outer circumferential surface 2e, the space G1 is hardly formed between the proximal end portion 31 and the outer circumferential surface 2e. Therefore, at the time of manufacturing the coil device 1, the magnetic material constituting the core 8 is less likely to enter between the proximal end portion 31 and the outer circumferential surface 2e of the wound portion 2. This makes it possible to prevent a short circuit failure between the proximal end portion 31 and the outer circumferential surface 2e via the magnetic material. In addition, since the proximal end portion 31 is disposed in the vicinity of the outer circumferential surface 2e, the number of turns of the wound portion 2 can be increased, and the magnetic properties of the coil device 1 can be improved.

Further, the winding axis of the wound portion 2 is offset to one side with respect to the center of the core 8, and the one side is a side where the leadout portion 3a is disposed. Therefore, an installation space of the leadout portion 3a can be secured ahead of the leadout portion 3a inside the core 8, and the leadout portion 3a can be easily disposed inside the core 8. In addition, it is possible to secure an installation space of the wire connecting portion 42a (FIG. 2) ahead of the leadout portion 3a inside the core 8, and it is easy to install the wire connecting portion 42a inside the core 8.

In addition, it is easy to secure a volume of the core 8 on the fifth surface 8e side of the core 8. Therefore, the wire connecting portions 42a and 42b and the leadout portions 3a and 3b can be prevented from being exposed from the core 8, and can be protected by the core 8. In addition, since a space for disposing the wire connecting portions 42a and 42b is formed on the fifth surface 8e side of the core 8, it is not necessary to expand the core 8 to the fifth surface 8e side in order to secure the space, and the coil device 1 can be downsized.

Further, the outer circumferential surface 2e of the wound portion 2 can be disposed at a position separated from the fifth surface 8e of the core 8. Therefore, it is possible to sufficiently secure the thickness of the core 8 between the outer circumferential surface 2e and the fifth surface 8e of the core 8, and it is possible to prevent occurrence of a crack in the fifth surface 8e of the core 8.

In addition, the coil device 1 has a leadout portion 3a and a leadout portion 3b displaced from the leadout portion 3a along the winding axis of the wound portion 2. The leadout portion 3a is provided with a bent portion 33a, and the leadout portion 3b is provided with a bent portion 33b. Therefore, depending on a bending degree of the bent portion 33a, a part of the leadout portion 3a is disposed in the vicinity of the outer circumferential surface 2e of the wound portion 2, and the space G1 is hardly formed between the leadout portion 3a and the outer circumferential surface 2e. Further, depending on a bending degree of the bent portion 33b, a part of the leadout portion 3b is disposed in the vicinity of the outer circumferential surface 2e of the wound portion 2, and the space G2 is hardly formed between the leadout portion 3b and the outer circumferential surface 2e. Therefore, at the time of manufacturing the coil device 1, the magnetic material constituting the core 8 is less likely to enter between the leadout portion 3a and the outer circumferential surface 2e, and further, between the leadout portion 3b and the outer circumferential surface 2e. As a result, it is possible to prevent the short circuit failure between the leadout portion 3a and the outer circumferential surface 2e, and further, between the leadout portion 3b and the outer circumferential surface 2e via the magnetic material.

The leadout portion 3a is provided with a distal end portion 32, and the leadout portion 3b is provided with a distal end portion 32. An interval between the distal end portion 32 of the leadout portion 3a and the distal end portion 32 of the leadout portion 3b is smaller than a maximum diameter of the wound portion 2 (a length along the X-axis between the outermost end 2g and the outermost end 2h). Therefore, depending on the interval between the distal end portion 32 of the leadout portion 3a and the distal end portion 32 of the leadout portion 3b, the interval between the leadout portion 3a and the outer circumferential surface 2e of the wound portion 2, and further, the interval between the leadout portion 3b and the outer circumferential surface 2e of the wound portion 2 can be narrowed. Accordingly, it is possible to effectively prevent the space G1 from being formed between the leadout portion 3a and the outer circumferential surface 2e of the wound portion 2. In addition, it is possible to effectively prevent the space G2 from being formed between the leadout portion 3b and the outer circumferential surface 2e of the wound portion 2.

### Second Embodiment

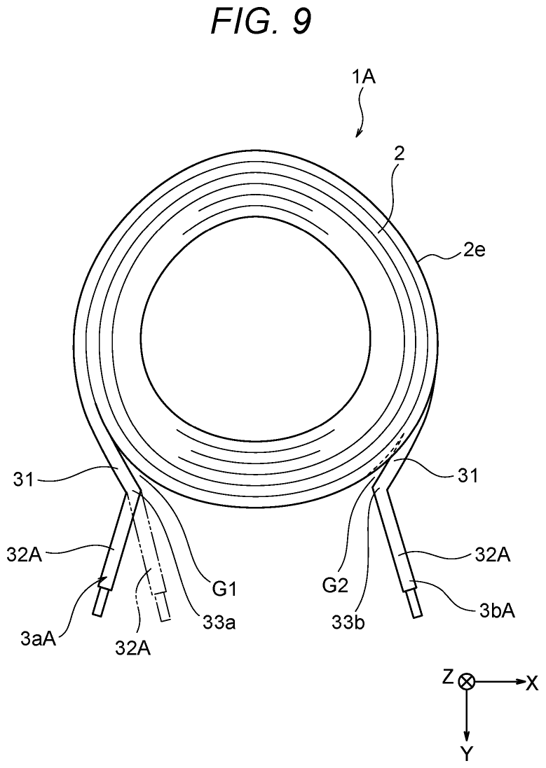

A coil device 1A of a second embodiment illustrated in FIG. 9 has the same configuration as the coil device 1 of the first embodiment except for the following points. Portions overlapping with the coil device 1 of the first embodiment are denoted by the same reference numerals, and a detailed description thereof will be omitted. In FIG. 9, only a wound portion 2 and leadout portions 3aA and 3bA are illustrated.

The leadout portions 3aA and 3bA have distal end portions 32A. The distal end portion 32A is led out in a direction inclined outward (a side away from the center of the wound portion 2) with respect to the Y-axis. As indicated by a two-dot chain line in FIG. 9, the distal end portion 32A may be led out in a direction inclined inward with respect to the Y-axis. Also in the present embodiment, the same effects as those of the first embodiment can be obtained.

### Third Embodiment

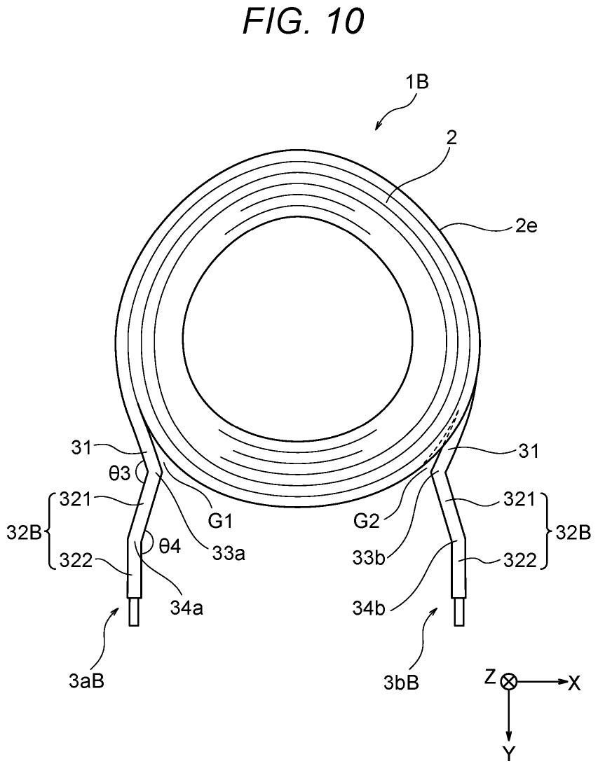

A coil device 1B of a third embodiment illustrated in FIG. 10 has the same configuration as the coil device 1 of the first embodiment except for the following points. Portions overlapping with the coil device 1 of the first embodiment are denoted by the same reference numerals, and a detailed description thereof will be omitted. In FIG. 10, only a wound portion 2 and leadout portions 3aB and 3bB are illustrated.

The leadout portion 3aB has a distal end portion 32B and bent portions 33a and 34a. The leadout portion 3bB has a distal end portion 32B and bent portions 33b and 34b. The inner angle of each of the bent portions 33a and 34a is an obtuse angle, and the inner angle of each of the bent portions 33b and 34b is an obtuse angle. In the present embodiment, the two bent portions 33a and 34a are formed in the leadout portion 3aB, but the number of bent portions may be three or more. Although two bent portions 33b and 34b are formed in the leadout portion 3bB, the number of bent portions may be three or more.

An inner angle θ3 of the bent portion 33a is smaller than an inner angle θ4 of the bent portion 34a, but may be larger than the inner angle θ4. Alternatively, the inner angle θ3 of the bent portion 33a may be equal to the inner angle θ4 of the bent portion 34a. The same applies to the inner angle of the bent portion 33b and the inner angle of the bent portion 34b.

The distal end portion 32B has a first portion 321 and a second portion 322 continuous with the first portion 321. The bent portion 33a or 33b is formed at an intersection of the proximal end portion 31 and the first portion 321. The bent portion 34a or 34b is formed at an intersection of the first portion 321 and the second portion 322. A length of the first portion 321 in the extending direction is shorter than a length of the second portion 322 in the extending direction, but may be longer than this. Alternatively, the length of the first portion 321 in the extending direction may be equal to the length of the second portion 322 in the extending direction.

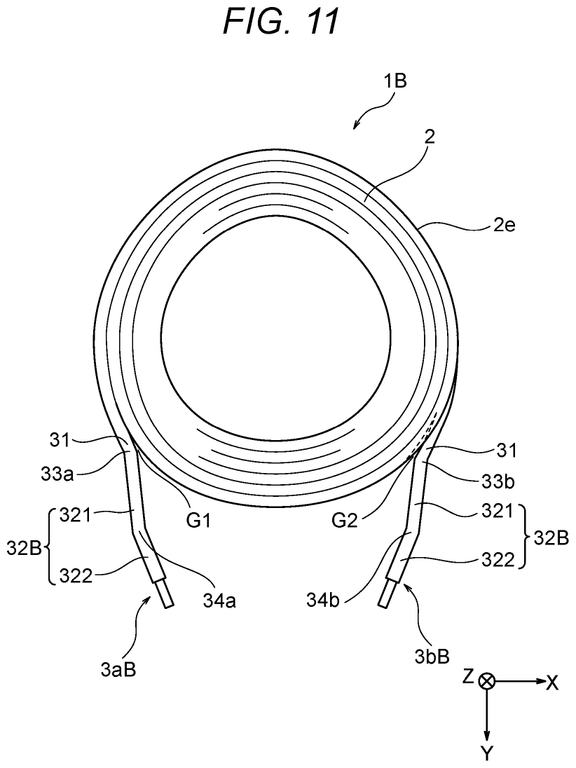

The first portion 321 is led out in a direction inclined outward (a side away from the center of the wound portion 2) with respect to the Y-axis. However, as illustrated in FIG. 11, the first portion 321 may be led out in a direction inclined inward with respect to the Y-axis.

As illustrated in FIG. 10, the second portion 322 is led out along the Y-axis. However, the second portion 322 may be led out in a direction inclined outward (a side away from the center of the wound portion 2) with respect to the Y-axis. Alternatively, as illustrated in FIG. 11, the second portion 322 may be led out in a direction inclined inward with respect to the Y-axis.

Also in the present embodiment, the same effects as those of the first embodiment can be obtained. In addition, as illustrated in FIG. 10, in the present embodiment, the leadout portion 3aB is provided with bent portions 33a and 34a. Therefore, a part of the leadout portion 3aB can be disposed in the vicinity of the outer circumferential surface 2e of the wound portion 2 based on the bent portion 33a, and the leadout destination of the leadout portion 3aB can be disposed in the vicinity of the wire connecting portion 42a (FIG. 2) based on the bent portion 34a. Accordingly, the leadout portion 3aB is easily coupled to the wire connecting portion 42a.

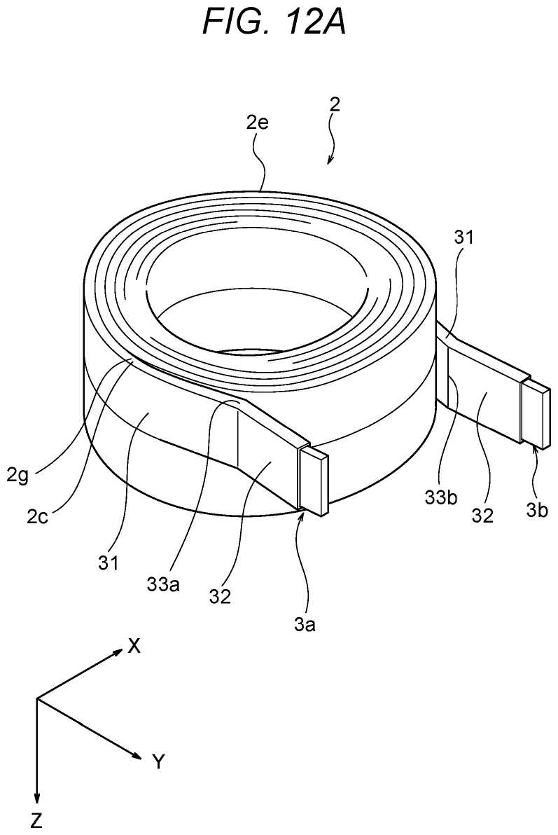

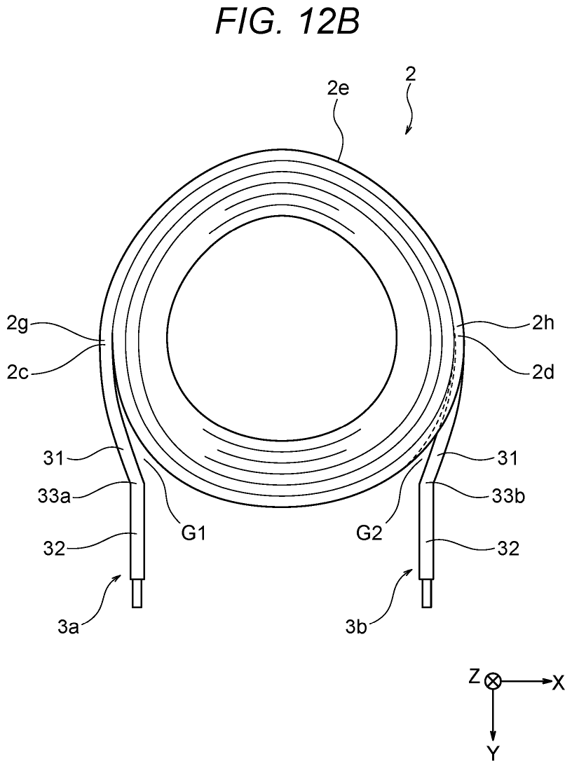

Note that the present invention is not limited to the above-described embodiments, and various modifications can be made within the scope of the present invention. In the first embodiment, as illustrated in FIGS. 12A and 12B, the first leadout position 2c of the leadout portion 3a may be located at the outermost end 2g of the wound portion 2. The second leadout position 2d of the leadout portion 3b may be located at the outermost end 2h of the wound portion 2. That is, as viewed from the Y-axis direction (as viewed from the fifth surface 8e side of the core 8 in FIG. 2), the leadout portions 3a and 3b may be led out from positions where the diameter of the outer circumferential surface 2e of the wound portion 2 is maximum. In this case, the space G1 is formed from the vicinity of the bent portion 33a to the outermost end 2g. The space G2 is formed from the vicinity of the bent portion 33b to the outermost end 2h. The same applies to the second embodiment and the third embodiment.

In each of the above embodiments, both the outer circumferential surface 2e of the wound portion 2 and the outer circumferential surface 51e of the center core portion 51 have a bulging shape (distorted shape). However, the outer circumferential surface 2e of the wound portion 2 and the outer circumferential surface 51e of the center core portion 51 may not have the bulging shape (distorted shape). The same applies to the second embodiment and the third embodiment.

In each of the above embodiments, both the outer circumferential surface 2e of the wound portion 2 and the outer circumferential surface 51e of the center core portion 51 have a convex shape (distorted shape). However, the outer circumferential surface 2e of the wound portion 2 and the outer circumferential surface 51e of the center core portion 51 may not have a convex shape (distorted shape). The same applies to the second embodiment and the third embodiment.

In the first embodiment, the bent portion is formed in both the leadout portions 3a and 3b. However, the bent portion may be formed only in one of the leadout portions 3a and 3b. The same applies to the second embodiment and the third embodiment.

In each of the above embodiments, the wire 10 is formed of a flat wire, but may be formed of a wire other than a flat wire, such as a round wire, a stranded wire, a litz wire, or a braided wire.

In each of the above embodiments, the core 8 is configured by two cores of the first core 5 and the second core 6, but the core 8 of the coil device 1 may be configured by only one core. In this case, the core 8 may be formed inside the mold by powder compaction, injection molding, or the like.

In each of the above embodiments, the application example of the present disclosure to the inductor has been described, but the present disclosure may be applied to a coil device other than an inductor.

### REFERENCE SIGNS LIST

1, 1A, 1B coil device
2 wound portion
2c first leadout position
2d second leadout position
2e outer circumferential surface
2f inner circumferential surface
2g, 2h outermost end
2i most distal end
2j most proximal end
3a, 3b, 3aA, 3bA, 3aB, 3bB leadout portion
31 proximal end portion
32, 32A, 32B distal end portion
321 first portion
322 second portion
33a, 33b, 34a, 34b bent portion
4a, 4b terminal
41a, 41b base portion
410a, 410b first branch portion
411a, 411b second branch portion
412a, 412b first curved portion
413a, 413b second curved portion
42a, 42b wire connecting portion
420a cutout portion
43a, 43b intermediate portion
44a, 44b substrate connecting portion
45a, 45b recess
5 first core
50 base portion
51 center core portion
51e outer circumferential surface
52 recess
6 second core
60 main body portion
61 accommodation hole
62a, 62b accommodation groove
63a, 63b connecting groove
64, 65 recess
66 bottom portion
7 frame
8 core
80 side recess
9 melted portion
10 wire
11 coating film
G1, G2 space

What is claimed is:

1. A coil device comprising:
a wound portion;
a leadout portion led out from the wound portion;
a terminal including a wire connecting portion connected to the leadout portion; and
an element body covering the wound portion, the leadout portion and the wire connecting portion, wherein
a winding axis of the wound portion is perpendicular to a mounting facing surface of the element body,
the leadout portion has a bent portion bent so as to protrude inward when viewed along the winding axis, and
an inner angle of the bent portion is an obtuse angle.

2. The coil device according to claim 1, wherein the bent portion is adjacent to an outer circumferential surface of the wound portion.

3. The coil device according to claim 1, wherein
the leadout portion has a proximal end portion located on one side of the bent portion and a distal end portion located on another side of the bent portion, and
the proximal end portion is closer to the outer circumferential surface of the wound portion than the distal end portion.

4. The coil device according to claim 1, wherein the winding axis of the wound portion is offset to a one side with respect to a center of the element body, and
the one side is a side where the leadout portion is disposed.

5. The coil device according to claim 1, wherein
the leadout portion has a first leadout portion and a second leadout portion displaced from the first leadout portion along the winding axis of the wound portion, and
the bent portion has a first bent portion provided in the first leadout portion and a second bent portion provided in the second leadout portion.

6. The coil device according to claim 3, wherein
the distal end portion has a first distal end portion provided in the first leadout portion and a second distal end portion provided in the second leadout portion, and
an interval between the first distal end portion and the second distal end portion is smaller than a maximum diameter of the wound portion.

7. The coil device according to claim 1, wherein the leadout portion is provided with the bent portions.

8. The coil device according to claim 1, wherein the wound portion is a flat wire wound in a spiral shape.
